(19) United States
(12) Patent Application Publication
(10) Pub. No.: US 2013/0315582 A1
(43) Pub. Date: Nov. 28, 2013

(54) OPTICAL COMMUNICATION MODULE, METHOD FOR RECORDING LOG OF OPTICAL COMMUNICATION MODULE, AND OPTICAL COMMUNICATION APPARATUS

(71) Applicants: Yasuyuki Kawanishi, Osaka (JP); Shojiro Kiyotake, Osaka (JP)

(72) Inventors: Yasuyuki Kawanishi, Osaka (JP); Shojiro Kiyotake, Osaka (JP)

(73) Assignees: SUMITOMO ELECTRIC NETWORKS, INC., Shinagawa-ku, Tokyo (JP); SUMITOMO ELECTRIC INDUSTRIES, LTD., Osaka-shi, Osaka (JP)

(21) Appl. No.: 13/985,197

(22) PCT Filed: Aug. 9, 2012
(86) PCT No.: PCT/JP2012/070330

§ 371 Date: Aug. 13, 2013

(30) Foreign Application Priority Data
Dec. 21, 2011 (JP) 2011-279563

(51) Int. Cl. H04B 10/07

(52) U.S. Cl. CPC H04B 10/07
USPC 398/17

(57) ABSTRACT

An optical communication module includes a control unit and a nonvolatile memory. The control unit detects an abnormality of the optical communication module, generates log information regarding the detected abnormality, and writes the log information in the nonvolatile memory. After the number of times the log information has been written in the nonvolatile memory has reached a predetermined number of times, the control unit does not write log information in the nonvolatile memory. Accordingly, the number of times the nonvolatile memory is permitted to be written can be prevented from considerably decreasing.

### TECHNICAL FIELD

The present invention relates to an optical communication module, a method for recording a log of an optical communication module, and an optical communication apparatus. More specifically, the present invention relates to an optical communication module configured to store log information.

### BACKGROUND ART

An optical transceiver is a kind of optical communication module. The optical transceiver generally has a capability of converting an electrical signal and an optical signal to and from each other, a capability of receiving an optical signal from an optical communication cable, and a capability of transmitting an optical signal to an optical communication cable. Where the optical transceiver fails, a technical expert of the manufacturer of the transceiver may analyze the optical transceiver. Japanese Patent Laying-Open No. 2004-222297 (PTD 1) or WO2005/107105 (PTD 2) discloses a method according to which information about an optical transceiver is held in the optical transceiver.

### CITATION LIST

### Patent Document

PTD 1: Japanese Patent Laying-Open No. 2004-222297
PTD 2: WO2005/107105

### SUMMARY OF INVENTION

### Technical Problem

In the case where an abnormality occurs to optical communication, it is important for a provider of the optical communication system to immediately return the optical communication to a normal state. In many cases, one host substrate is mounted with a plurality of optical communication modules (optical transceivers in many cases). If a certain host substrate is the cause of an abnormality of the optical communication, the provider usually considers replacing the host substrate. Therefore, even if a plurality of optical communication modules mounted on the host substrate are estimated to have caused the abnormality, the host substrate may be replaced.

In view of such an operation as described above, a host substrate may be mounted with a memory (nonvolatile memory for example) for storing log information about the state of the whole of the host substrate. A technical expert of the manufacturer of the optical communication modules can test an optical communication module itself to determine whether or not this optical communication module is failing. However, in order to ascertain in what situation the optical communication module enters a failure state, it is necessary to analyze the log information held in the memory of the host substrate.

In this case, the technical expert of the manufacturer has to analyze the log information into information concerning the optical communication module and information other than this. Moreover, the technical expert of the manufacturer has to estimate the situation in which the optical communication module enters a failure state, based on the log information concerning the optical communication module. The technical expert of the manufacturer of the optical communication module is therefore required to spend much effort so as to know the situation in which the optical communication module enters a failure state.

Where only the optical communication module which has failed is returned to the technical expert of the manufacturer, the technical expert of the manufacturer cannot know the situation in which the optical communication module enters a failure state, because the log information concerning the optical communication module is stored in the memory of the host substrate.

In order to solve this problem, a method according to which information is held in the optical transceiver, like the one disclosed in above-referenced Japanese Patent Laying-Open No. 2004-222297 (PTD 1) or WO2005/107105 (PTD 2), can be adopted to configure the optical communication module. However, it is more important for analysis of the cause of the failure of the optical communication module to have the information about the situation in which the optical communication module enters the failure state. Above-referenced PTD 1 and PTD 2 are both silent about the method for leaving, in the optical communication module, information about the situation in which the optical communication module enters a failure state.

Japanese Patent Laying-Open No. 2004-222297 (PTD 1) also discloses that any of a volatile storage device and a nonvolatile storage device may be used as a memory for storing information about a failure. In the case where the volatile storage device is used, however, stoppage of supply of a power supply voltage to the optical communication module causes the information stored in the volatile storage device to be lost. Accordingly, there is a possibility that the information stored in the optical communication module is lost when the power supply voltage becomes unable to be supplied to the optical communication module due to occurrence of an abnormality to the host substrate itself or when the host substrate is removed from an optical communication apparatus.

In contrast, in the case where the optical communication module is mounted with a nonvolatile storage device and the nonvolatile storage device stores the information, the optical communication module can still hold the information even if the optical communication module is removed from the host substrate. As the nonvolatile storage device, EEPROM (Electrically Erasable Programmable Read-Only Memory) or flash ROM may be used. However, such a nonvolatile semiconductor memory is generally limited in the write count, namely the number of times it is written (a few thousands of times for example). Therefore, if the nonvolatile semiconductor memory is configured so that information can be written therein without taking into consideration such a limitation of the write count, there is a possibility that the lifetime of the nonvolatile semiconductor memory is shortened.

For example, in order to leave, in the optical communication module, information about the state in which the optical communication module enters a failure state, it is possible to leave in the optical communication module the information about symptoms of an abnormality of the optical communication module, as log information. However, if the optical communication module erroneously detects the abnormality, it is possible that the log information is written in the nonvolatile semiconductor memory at predetermined intervals (one second for example). If the nonvolatile semiconductor memory is thus written frequently, the lifetime of the optical communication module can be shortened depending on the lifetime of the nonvolatile semiconductor memory.

As seen from the foregoing, there has been proposed no technology for leaving in the optical communication module the information about the state in which the optical communication module enters a failure state. Further, if the technology of PTDs 1 and 2 is used to leave the information in the optical communication module and the nonvolatile semiconductor memory is frequently written, there is a possibility that the lifetime of the optical communication module is shortened.

An object of the present invention is to enable, log information concerning the situation in which an optical communication module enters a failure state, to be left in the optical communication module, and to prevent the lifetime of the optical communication module from shortening due to recording of the log information.

### Solution to Problem

An optical communication module according to an aspect of the present invention is an optical communication module which is insertable in and removable from a host substrate and includes a control unit for detecting an abnormality of the optical communication module and a nonvolatile memory. The control unit generates and writes, in the nonvolatile memory, log information regarding a detected abnormality and, after the number of times the log information has been written in the nonvolatile memory has reached a predetermined number of times, the control unit does not write the log information in the nonvolatile memory.

Owing to the above-described features, the log information regarding the abnormality detected by the control unit is stored in the nonvolatile memory. Thus, the log information regarding the situation in which the optical communication module enters a failure state can be left in the optical communication module. For example, information from which it is seen that the temperature of the optical communication module was abnormally high immediately before the optical communication module failed can be left, as the log information, in the optical communication module. Further, after the number of times the log information has been written in the nonvolatile memory has reached a predetermined number of times, the log information will not newly be written. Thus, a considerable reduction of the number of times the nonvolatile memory is permitted to be written, due to frequent recording of the log information in the nonvolatile memory, can be prevented. The lifetime of the nonvolatile memory is prevented from being considerably shortened, and accordingly shortening of the lifetime of the optical communication module depending on the lifetime of the nonvolatile memory can be prevented. “Optical communication module” may have both the transmission and reception capabilities like the optical transceiver, or have only one of the transmission and reception capabilities (like optical receiver or optical transmitter for example).

Preferably, the control unit erases the log information in the nonvolatile memory, in accordance with an erasure instruction that is given to the control unit.

Owing to this feature, even when the control unit erroneously detects an abnormality and accordingly the number of times the log information is written in the nonvolatile memory reaches a predetermined number of times, the optical communication module can be used again. The way to give the instruction to erase to the control unit is not particularly limited.

Preferably, the log information includes at least information regarding a time identifying occurrence of an abnormality of the optical communication module.

Owing to this feature, the time when the abnormality occurred to the optical communication module can be ascertained. For example, information about an event which occurred at this time can be used to analyze the cause of the failure of the optical communication module. “A time identifying occurrence of an abnormality” may be the time when the abnormality occurred, the time when the log information was generated, or the time when the log information is written in the nonvolatile memory.

Preferably, the abnormality detected by the control unit includes at least one of an abnormality in temperature of the optical communication module, an abnormality in intensity of communication light of the optical communication module, and an abnormality in power supply voltage of the optical communication module.

Owing to this feature, more detailed information about the situation in which the optical communication module enters a failure state can be obtained. For example, in the case where a plurality of abnormalities are detected, log information regarding at least one of these abnormalities can be written in the nonvolatile memory. “Communication light” is defined depending on the capability of the optical communication module. If the optical communication module is implemented as an optical receiver for example, “communication light” is the light received by the optical receiver. If the optical communication module is implemented as an optical transmitter for example, “communication light” is the light transmitted by the optical transmitter. If the optical communication module is implemented as an optical transceiver, “communication light” can be one of or both the light transmitted by and the light received by the optical transceiver.

Preferably, the predetermined number of times is once or a plurality of times smaller than a limitation of the number of times the nonvolatile memory is written.

Owing to this feature, considerable shortening of the lifetime of the nonvolatile memory can be prevented. If the predetermined number of times is multiple times, the log information regarding an abnormality which has occurred multiple times, including the abnormality which has occurred first, can be stored in a nonvolatile manner in the optical communication module. Thus, the log information regarding a situation in which the optical communication module enters a failure state can be left in the optical communication module.

A method for recording a log of an optical communication module, according to another aspect of the present invention, includes the steps of: detecting an abnormality of an optical communication module insertable in and removable from a host substrate; writing, in a nonvolatile memory mounted in the optical communication module, log information regarding the abnormality of the optical communication module; and inhibiting the log information from being written in the nonvolatile memory after the number of times the log information has been written in the nonvolatile memory has reached a predetermined number of times.

Owing to the above-described features, the log information regarding a situation in which the optical communication module enters a failure state can be left in the optical communication module. Further, a considerable reduction of the number of times the nonvolatile memory is permitted to be written, due to frequent recording of the log information in the nonvolatile memory, can be prevented. Accordingly, shortening of the lifetime of the optical communication module depending on the lifetime of the nonvolatile memory, can be prevented.

An optical communication apparatus according to still another aspect of the present invention includes a host substrate and an optical communication module. The optical communication module includes a first nonvolatile memory and is insertable in and removable from the host substrate. The optical communication module detects an abnormality of the optical communication module itself and writes, in the first nonvolatile memory, first log information regarding the detected abnormality. The host substrate includes a control unit and a second memory. The control unit monitors a situation of the optical communication apparatus and generates second log information regarding the monitoring. The second memory stores the second log information in a nonvolatile manner. After the number of times the first log information has been written has reached a predetermined number of times, the optical communication module does not write the first log information in the first nonvolatile memory. The first log information and the second log information each include at least a time.

Owing to these features, the log information regarding the situation in which the optical communication module enters a failure state can be left in the optical communication module. Further, a considerable reduction of the number of times the nonvolatile memory is permitted to be written, due to frequent recording of the first log information in the nonvolatile memory in the optical communication module, can be prevented. Therefore, shortening of the lifetime of the optical communication module depending on the lifetime of the nonvolatile memory can be prevented. Further, the first log information and the second log information can be checked against each other to keep the integrity of an event which occurred when the abnormality of the optical communication module occurred. Therefore, when the optical communication module fails, the cause of the failure can more accurately be ascertained. The information about the time included in “second log information regarding the monitoring” indicates that the situation of the host substrate has been monitored by the control unit. The second log information may include not only the time but also the information about the situation of the host substrate at this time. “To store the second log information in a nonvolatile manner” means a state in which the second log information is held in the second memory in such a manner that enables the second log information to be retrieved from the second memory. Therefore, the second memory is a memory capable of still holding information without being supplied with a power supply voltage, like EEPROM for example.

### Advantageous Effects of Invention

In accordance with the present invention, log information regarding the situation in which an optical communication module enters a failure state can be left in the optical communication module. Further, in accordance with the present invention, shortening of the lifetime of the optical communication module due to recording of the information can be prevented.

### BRIEF DESCRIPTION OF DRAWINGS

FIG. 1 is a schematic configuration diagram of an optical communication apparatus in a first embodiment of the present invention.

FIG. 2 is a block diagram showing an example configuration of an optical transceiver 1 shown in FIG. 1.

FIG. 3 is a block diagram showing a configuration of a controller 20 shown in FIG. 2.

FIG. 4 is a diagram showing an example memory map of a nonvolatile memory shown in FIG. 3.

FIG. 5 is a diagram illustrating an example configuration of log information 42 stored in a log information storage area 41 shown in FIG. 4.

FIG. 6 is a flowchart showing a process when the optical transceiver in the first embodiment is started up.

FIG. 7 is a flowchart showing a process of a main routine of the optical transceiver in the first embodiment.

FIG. 8 is a flowchart illustrating a process for changing a ROM protect code to 80h.

FIG. 9 is a flowchart showing a process of a main routine of an optical transceiver in a second embodiment.

FIG. 10 is a diagram showing abnormalities of an optical transceiver that can be detected by the optical transceiver in a third embodiment.

FIG. 11 is a flowchart showing a process of a main routine of the optical transceiver in the third embodiment.

FIG. 12 is a flowchart showing another example of the process of the main routine of the optical transceiver in the third embodiment.

### DESCRIPTION OF EMBODIMENTS

In the following, embodiments of the present invention will be described in detail with reference to the drawings. In the drawings, the same or corresponding components are denoted by the same reference characters, and a description thereof will not be repeated.

### First Embodiment

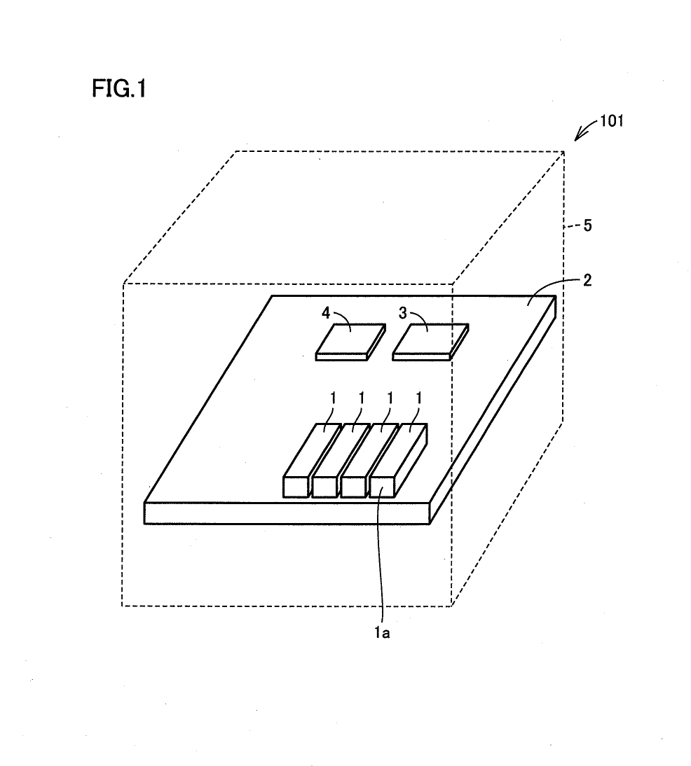

FIG. 1 is a schematic configuration diagram of an optical communication apparatus in a first embodiment of the present invention. Referring to FIG. 1, optical communication apparatus 101 includes a plurality of optical transceivers 1, a host substrate 2, and a casing 5. Optical transceivers 1 are shown in FIG. 1 as one specific form of the optical communication module of the present invention.

A plurality of optical transceivers 1 are mounted on host substrate 2. A plurality of optical transceivers 1 are pluggable optical transceivers. Namely, optical transceiver 1 is configured to be insertable in and removable from host substrate 2.

Optical transceiver 1 converts an electrical signal sent from host substrate 2 into an optical signal and outputs the optical signal to an optical network. Optical transceiver 1 also converts an optical signal sent through the optical network into an electrical signal and sends the electrical signal to host substrate 2. A front face 1a of optical transceiver 1 is configured so that a connector (not shown) provided at an end of an optical communication cable is attachable to and detachable from front face 1a of optical transceiver 1, which, however, is not shown in detail in FIG. 1.

Host substrate 2 is installed in casing 5. Casing 5 may for example be a rack. The direction in which host substrate 2 is oriented is not particularly limited. FIG. 1 shows, for the sake of ease of recognition of a plurality of optical transceivers 1 and host substrate 2, an arrangement where the surface of host substrate 2 is parallel to the horizontal direction. Host substrate 2 may be arranged in the manner shown in FIG. 1. Alternatively, host substrate 2 may be arranged upright (host substrate 2 is placed to stand in the vertical direction).

Host substrate 2 is mounted with a host CPU (Central Processing Unit) 3 and a nonvolatile memory 4. Host CPU 3 and nonvolatile memory 4 are shown as typical devices mounted on host substrate 2.

Host CPU 3 communicates with each of a plurality of optical transceivers 1. Host CPU 3 further generates log information concerning monitoring of the situation of host substrate 2 by host CPU 3. The log information is stored in nonvolatile memory 4. The log information stored in nonvolatile memory 4 includes at least information about a time. The information about a time suggests that host CPU 3 monitored the situation of host substrate 2. Not only the time but also the situation of host substrate 2 at that time may be stored as the log information in nonvolatile memory 4.

Nonvolatile memory 4 is a memory in which information can be written and the information can be stored in a nonvolatile manner. Nonvolatile memory 4 is implemented for example by an EEPROM. Host CPU 3 and nonvolatile memory 4 may be integrated into one unit.

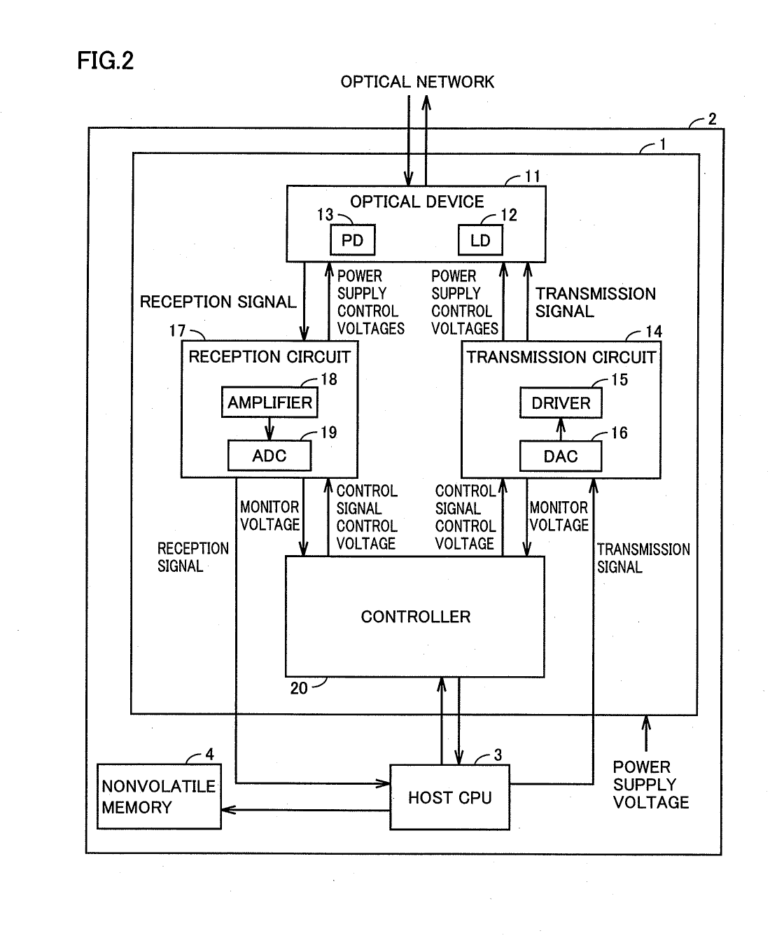

FIG. 2 is a block diagram showing an example configuration of optical transceiver 1 shown in FIG. 1. Referring to FIG. 2, optical transceiver 1 includes an optical device 11, a transmission circuit 14, a reception circuit 17, and a controller 20.

Optical device 11 includes a laser diode (LD) 12 and a photodiode (PD) 13. Laser diode 12 receives a power supply control voltage that are fed from transmission circuit 14. Laser diode 12 converts an electrical signal (transmission signal) which is sent from transmission circuit 14 into an optical signal and outputs the optical signal through an optical cable (not shown) to the optical network.

Photodiode 13 receives a power supply voltage and a control voltage that are fed from reception circuit 17. Photodiode 13 receives an optical signal through an optical cable (not shown) from the optical network and converts the optical signal into an electrical signal. Photodiode 13 outputs the electrical signal as a reception signal to reception circuit 17.

Transmission circuit 14 includes a driver 15 for feeding the power supply voltage and the control voltage to laser diode 12. Transmission circuit 14 further includes a D/A converter (DAC) 16. D/A converter 16 converts a digital transmission signal which is sent from host CPU 3 into an analog signal. Driver 15 applies the analog signal to laser diode 12. Further, transmission circuit 14 outputs to controller 20 a monitor voltage indicating a state of transmission circuit 14 or laser diode 12. This monitor voltage is for example a voltage representing the intensity of light which is output by laser diode 12.

Reception circuit 17 feeds the power supply voltage and the control voltage to photodiode 13. Reception circuit 17 includes an amplifier 18 and an A/D converter (ADC) 19. Amplifier 18 amplifies the reception signal (analog signal) which is sent from photodiode 13. A/D converter 19 converts the amplified analog signal into a digital signal. Reception circuit 17 outputs this digital signal to host CPU 3. Further, reception circuit 17 outputs to controller 20 a monitor voltage indicating a state of reception circuit 17 or photodiode 13. This monitor voltage is for example a voltage representing the intensity of light which is received by photodiode 13.

Controller 20 performs centralized control of optical transceiver 1. For this sake, controller 20 supplies a control signal and a control voltage to each of transmission circuit 14 and reception circuit 17. Further, based on the monitor voltage from each of transmission circuit 14 and reception circuit 17, controller 20 monitors the state of optical transceiver 1. Furthermore, in response to a request from host CPU 3, controller 20 transmits to host CPU 3 information about the state of optical transceiver 1.

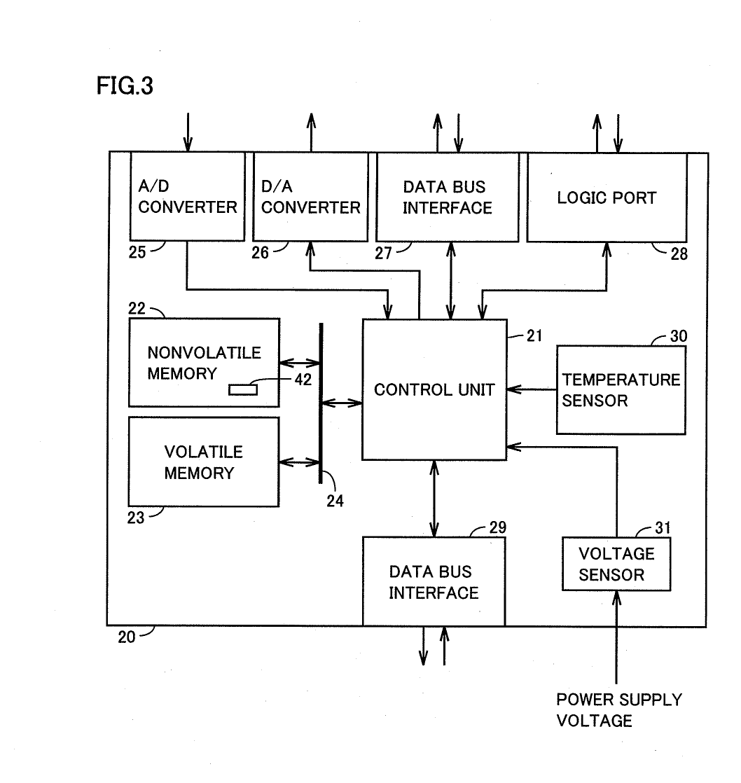

FIG. 3 is a block diagram showing a configuration of controller 20 shown in FIG. 2. The configuration shown in FIG. 3 can be implemented by either a plurality of semiconductor integrated circuits or a single semiconductor integrated circuit.

Referring to FIG. 3, controller 20 includes a control unit 21, a nonvolatile memory 22, a volatile memory 23, a bus 24, an A/D converter 25, a D/A converter 26, a data bus interface 27, a logic port 28, a data bus interface 29, a temperature sensor 30, and a voltage sensor 31.

Control unit 21 controls the operation of the whole of controller 20. Nonvolatile memory 22 is a memory in which information can be written and from which information can be read and further the information written therein can be stored in a nonvolatile manner. Nonvolatile memory 22 can still hold the information even while no power supply voltage is fed thereto, and is implemented for example by an EEPROM.

Regarding volatile memory 23, information can be written and read in and from the volatile memory. However, when the power supply voltage is stopped from being fed to volatile memory 23, the information stored in volatile memory 23 is lost. Volatile memory 23 is implemented for example by a DRAM (Dynamic Random Access Memory) or SRAM (Static Random Access Memory) or the like.

Bus 24 is provided for transmitting information for example between control unit 21 and nonvolatile memory 22 or between control unit 21 and volatile memory 23.

A/D converter 25 converts a monitor voltage which is sent from transmission circuit 14 or reception circuit 17 shown in FIG. 2 for example into a digital signal. A/D converter 25 outputs this digital signal to control unit 21. D/A converter 26 converts a digital control signal which is sent from control unit 21 for example into an analog control signal. D/A converter 26 outputs this analog control signal to transmission circuit 14 or reception circuit 17 shown in FIG. 2.

Data bus interface 27 is a circuit for transmitting and receiving data for example between transmission circuit 14 or reception circuit 17 shown in FIG. 2 and control unit 21. Logic port 28 is a circuit for control unit 21 for example to transmit a digital control signal to transmission circuit 14 or reception circuit 17. Data bus interface 27 is a circuit for transmission and reception of data between transmission circuit 14 or reception circuit 17 shown in FIG. 2 and control unit 21, for example. Data bus interface 29 is a circuit for control unit 21 for example to transmit and receive data to and from host CPU 3 or another device (another optical transceiver for example) mounted on host substrate 2.

Temperature sensor 30 detects the temperature of optical transceiver 1 and outputs a signal representing the temperature to control unit 21. Since temperature sensor 30 may at least be disposed inside optical transceiver 1, temperature sensor 30 may be provided separately from controller 20.

Voltage sensor 31 detects a power supply voltage which is fed to optical transceiver 1 and outputs to control unit 21 a signal representing this power supply voltage.

Control unit 21 monitors the state of optical transceiver 1. When control unit 21 detects an abnormality of optical transceiver 1, control unit 21 generates log information 42 regarding this abnormality. Control unit 21 writes this log information 42 in nonvolatile memory 22. In the present embodiment, a state in which the temperature of optical transceiver 1 has exceeded a certain reference value (predetermined upper limit) is detected, by control unit 21, as an abnormality of optical transceiver 1.

The number of times log information 42 regarding a detected abnormality can be written in nonvolatile memory 22 is determined in advance. Until the number of times log information 42 is written reaches a predetermined number of times, control unit 21 can write log information 42 in nonvolatile memory 22. When the number of times log information 42 is written reaches the predetermined number of times, nonvolatile memory 22 becomes a state in which log information 42 cannot be written therein.

In the present embodiment, the number of times log information 42 can be written in nonvolatile memory 22 (namely the above-referenced “predetermined number of times”) is one. In a normal state, log information 42 is not recorded in nonvolatile memory 22. Namely, log information concerning an abnormality which occurred first after startup of optical transceiver 1 is recorded in nonvolatile memory 22. After this log information 42 is recorded, control unit 21 sets nonvolatile memory 22 in a state in which write is inhibited.

After nonvolatile memory 22 is set in the write-inhibited state, log information 42 is not newly written in nonvolatile memory 22 even if a new abnormality occurs to optical transceiver 1. A specific method for not allowing log information 42 to be newly written in nonvolatile memory 22 is, for example, a method according to which control unit 21 does not generate log information. An alternative method may be as follows; even when control unit 21 generates log information, nonvolatile memory 22 will not accept this log information. By these methods, a state can be established that new log information will not be written in nonvolatile memory 22.

Control unit 21 can further erase log information in nonvolatile memory 22 in accordance with an instruction to erase that has been input to control unit 21.

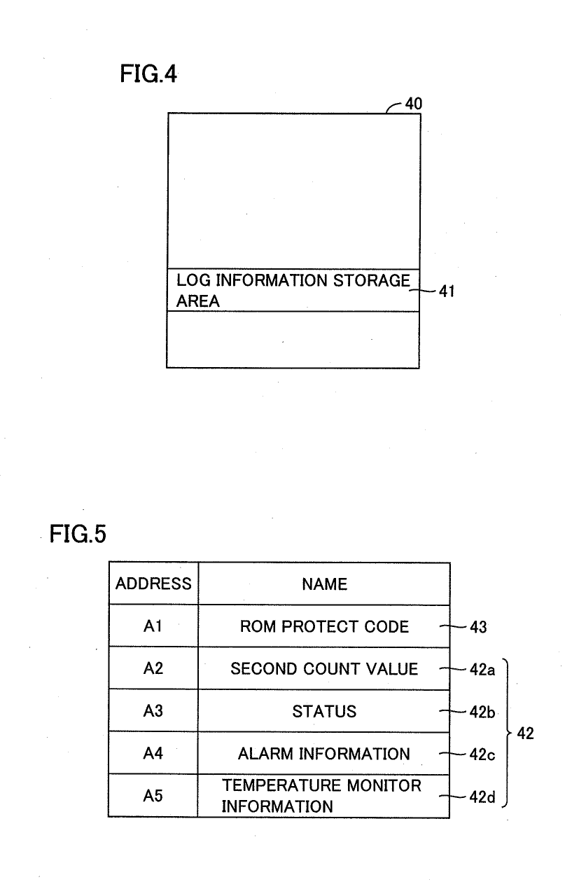

FIG. 4 is a diagram showing an example memory map of the nonvolatile memory shown in FIG. 3. Referring to FIG. 4, a part of the storage region of memory map 40 is allocated to serve as a log information storage area 41. The use of the remaining portion of the storage region is not particularly limited. Only control unit 21 can write log information in log information storage area 41. The log information stored in log information storage area 41 may be readable by only control unit 21 or readable by both control unit 21 and host CPU 3, for example.

FIG. 5 is a diagram illustrating an example configuration of log information 42 stored in log information storage area 41 shown in FIG. 4. Referring to FIGS. 4 and 5, log information 42 includes a second count value 42a, a status 42b, alarm information 42c, and temperature monitor information 42d. In log information storage area 41, an ROM protect code 43 is further stored.

To the ROM protect code, address A1 is allocated. To second count value 42a, status 42b, alarm information 42c, and temperature monitor information 42d, addresses A2 to A5 are allocated, respectively. Addresses A1 to A5 are determined depending on the size of ROM protect code 43 and respective sizes of the items of the log information, respectively.

ROM protect code 43 is a code indicating whether log information can be written or not in log information storage area 41 and indicating erasure of log information. For example, the three different codes below are set as ROM protect code 43, where “h” represents a hexadecimal number:

(1) “FFh” indicating that log information cannot be written;

(2) “00h” indicating that log information can be written; and

(3) “80h” indicating erasure of log information (initialization of log information storage area 41).

Initialization is performed when optical transceiver 1 is rebooted (optical transceiver 1 is re-powered up, for example).

Second count value 42a is information indicating a time identifying occurrence of an abnormality. This time may be a time when the abnormality occurred, a time when control unit 21 generated log information, or a time when control unit 21 writes log information in the nonvolatile memory. The second count value is a numerical value representing the seconds which have passed from startup of optical transceiver 1 to the time identifying occurrence of an abnormality.

Second count value 42a is generated inside the optical transceiver 1. For example, control unit 21 has a counter capability of incrementing the count value every one second. In order to enhance the precision of second count value 42a, a correction may be made. For example, if host substrate 2 includes a real-time clock circuit, control unit 21 may use a clock signal which is output from the real-time clock circuit to correct the second count value, and may include the corrected second count value in the log information.

Status 42b is a code representing a state of optical transceiver 1 when log information 42 is written. Alarm information 42c is information indicating the fact that an abnormality of optical transceiver 1 has occurred. In the case where the temperature of optical transceiver 1 has exceeded a reference value, a flag (“1” for example) representing this fact is stored as alarm information 42c. Temperature monitor information 42d is information indicating the temperature of optical transceiver 1 when the temperature thereof exceeds the reference value. Based on the output of temperature sensor 30, control unit 21 generates a value of the measured temperature, and includes, in log information 42, the value of the measured temperature as temperature monitor information 42d.

It is sufficient for log information 42 to include at least second count value 42a. In this case, the time when an abnormality occurred to optical transceiver 1 can be ascertained. For example, information about an event which occurred at that time can be used to analyze the cause of the abnormality of optical transceiver 1. In the present embodiment, it is one type of abnormality that is monitored by control unit 21. Therefore, as long as the time is included in log information 42, an abnormality which occurred at that time can be identified.

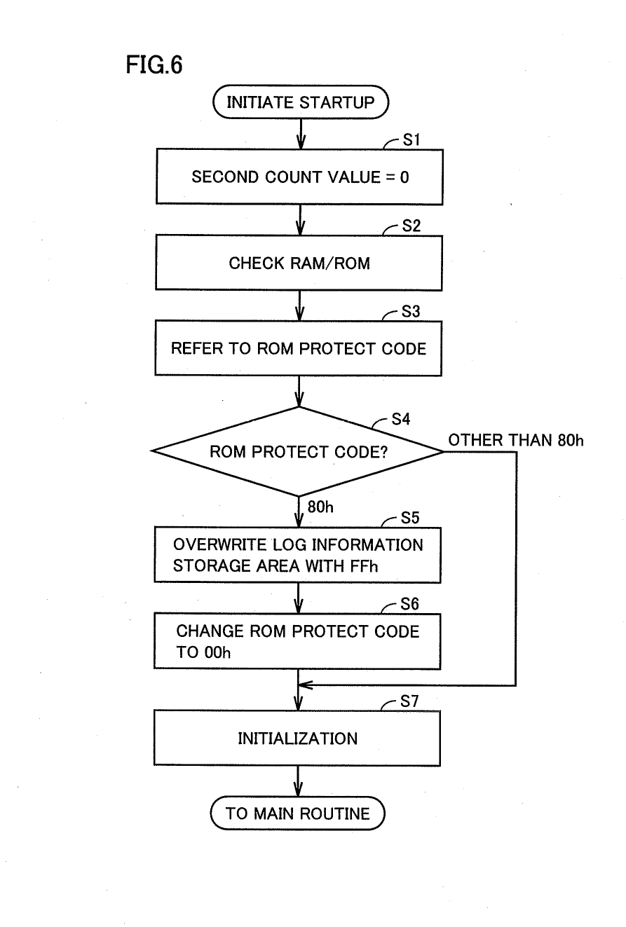

FIG. 6 is a flowchart showing a process when the optical transceiver in the first embodiment is started up. Referring to FIG. 6, in response to power-up of optical transceiver 1, startup of optical transceiver 1 is initiated. In step S1, control unit 21 sets the second count value to zero. In step S2, control unit 21 checks volatile memory 23 (RAM) and nonvolatile memory 22 (ROM).

In step S3, control unit 21 refers to ROM protect code 43 stored in nonvolatile memory 22. In step S4, control unit 21 determines whether ROM protect code 43 is “80h” or not. When ROM protect code 43 is “80h,” the process proceeds to step S5. In contrast, when ROM protect code 43 is a code other than “80h” (namely when it is “00h” or “FFh”), the process proceeds to step S7.

In step S5, control unit 21 overwrites all values in log information storage area 41 (see FIG. 4) with “FFh.” Accordingly, log information stored in log information storage area 41 is erased. After the erasure of the log information, control unit 21 changes in step S6 the ROM protect code from “80h” to “00h.” After this, nonvolatile memory 22 is in the state in which log information can be written therein.

In step S7, control unit 21 performs various kinds of initialization. After completion of the operation in step S7, the process of optical transceiver 1 proceeds to a main routine.

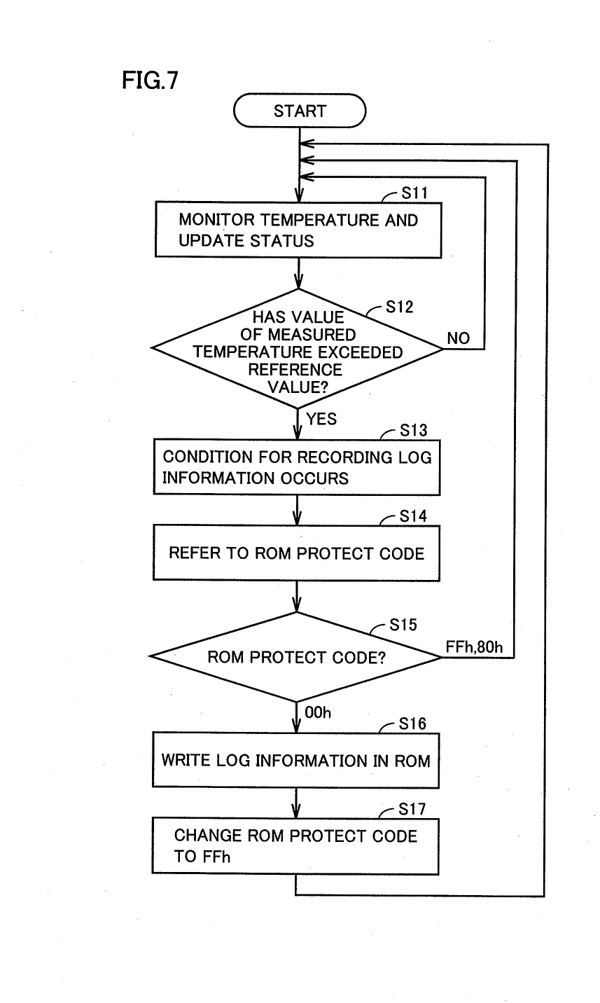

FIG. 7 is a flowchart showing a process of the main routine of the optical transceiver in the first embodiment. Referring to FIG. 7, the process of the main routine is started. In step S11, control unit 21 receives a measurement value of temperature sensor 30 to thereby monitor the temperature of optical transceiver 1. Further, in step S11, control unit 21 updates a status stored in control unit 21.

In step S12, control unit 21 determines whether or not the value of the measured temperature (measurement value of temperature sensor 30) has exceeded a reference value. When the value of the measured temperature is the reference value or less (NO in step S12), the process returns to step S11. Namely, when the value of the measured temperature is the reference value or less, respective operations in steps S11 and S12 are repeated. When the value of the measured temperature has exceeded the reference value (YES in step S12), the process proceeds to step S13.

In step S13, control unit 21 determines that a condition for recording log information has occurred. In step S14, control unit 21 refers to (reads) ROM protect code 43 stored in nonvolatile memory 22.

In step S15, control unit 21 determines whether ROM protect code 43 is “00h” or not. When ROM protect code 43 is a code other than “00h” (namely when it is “FFh” or “80h”), the process returns to step S11. Namely, when ROM protect code 43 is a code other than “00h,” control unit 21 does not write log information in nonvolatile memory 22 even if the condition for recording log information has occurred.

When ROM protect code 43 is “00h,” the process proceeds to step S16. In step S16, control unit 21 writes log information 42 in nonvolatile memory 22 (ROM). In step S17, control unit 21 changes ROM protect code 43 from “00h” to “FFh.” Respective operations in steps S16 and S17 are successively carried out in one write process.

After completion of the operation in step S17, the process returns to step S11. In this case, ROM protect code 43 has been changed from “00h” to “FFh” and therefore nonvolatile memory 22 is in the state in which information cannot be written therein. Therefore, in the process performed next time and thereafter, the process returns from step S15 to step S11 even when the value of measured temperature has exceeded the reference value (YES in step S12).

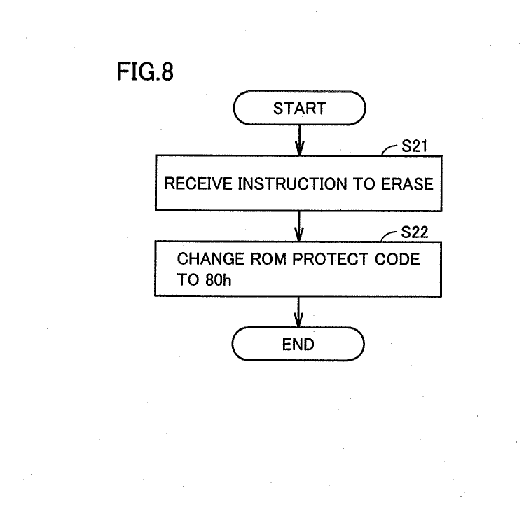

FIG. 8 is a flowchart illustrating a process for changing the ROM protect code to 80h. Although the ROM protect code before being changed may for example be “FFh,” it may be “00h” instead. Referring to FIG. 8, control unit 21 receives in step S21 an instruction to erase. The instruction to erase is sent to control unit 21 in the following way, for example.

Optical transceiver 1 is inserted in a socket of a substrate adapted to a test. This substrate is connected for example to a testing apparatus. A technical expert of the manufacturer of this optical transceiver 1 for example operates the testing apparatus to cause the instruction to erase to be transmitted from the testing apparatus through the substrate to control unit 21 of optical transceiver 1.

In step S22, control unit 21 changes the ROM protect code of nonvolatile memory 22 to 80h in accordance with the instruction to erase. When the operation in step S22 is completed, the process shown in FIG. 8 comes to an end. When optical transceiver 1 is started up next time, the process shown in FIG. 6 is performed.

According to the present embodiment, log information regarding an abnormality of optical transceiver 1 is stored in a nonvolatile manner in the optical transceiver which is insertable in and removable from host substrate 2. Therefore, in the case where this optical transceiver is an optical transceiver which has failed, the information regarding the situation in which the transceiver enters a failure state can be left inside the failing optical transceiver.

In the case where a plurality of optical transceivers 1 are connected to host substrate 2 as shown in FIG. 1 and one of the plurality of optical transceivers 1 has failed, it is unnecessary to remove the whole host substrate 2 from optical communication apparatus 101 and thereby return the substrate, and only the failing optical transceiver 1 may be returned. Therefore, the burden on the provider of the optical communication system that is required for returning the failing optical transceiver 1 can be reduced.

Further, in the case where an abnormality occurs to optical communication, it can easily be determined whether the cause of the abnormality is an optical transceiver or a host apparatus (host substrate). For example, the provider of the optical communication replaces the optical transceiver which has failed with a new (normal) optical transceiver. If the optical communication accordingly recovers from the abnormality, it is easily determined that the cause of the abnormality is the optical transceiver.

Further, in optical transceiver 1 which has failed, log information is stored in a nonvolatile manner. Accordingly, even in the case where a failure which will finally stop supply of power to optical transceiver 1 occurs, there is a high possibility that the log information remains in optical transceiver 1. For example, a technical expert of the manufacture can analyze the log information stored in the transceiver which has been returned due to its failure, to thereby ascertain the situation in which the optical transceiver enters a failure state.

Further, in the present embodiment, the number of times log information is recorded is limited to one. While the optical transceiver operates normally, log information is not recorded in nonvolatile memory 22. Namely, it is not until an abnormality occurs which will cause the optical transceiver to fail that log information is recorded in nonvolatile memory 22. Thus, information regarding the situation in which this optical transceiver 1 enters a failure state can be left in this optical transceiver 1. Furthermore, even if log information is written in the nonvolatile memory like EEPROM for which the number of times information is written in the memory is limited, the lifetime of the nonvolatile memory can be prevented from being considerably shortened. Accordingly, the possibility that the lifetime of optical transceiver 1 is shortened due to the limitation of writing in the nonvolatile memory can be reduced.

Further, in the present embodiment, log information which was once written in the nonvolatile memory can be erased. It is supposed by way of example that an abnormality of an optical transceiver has erroneously been detected in spite of the fact that no abnormality has occurred to the transceiver; in this case, the optical transceiver functions normally; in the nonvolatile memory, however, the log information is written.

In the present embodiment, in the case where log information is stored in the nonvolatile memory, new log information is inhibited from being written in the nonvolatile memory. Further, in the present embodiment, the log information stored in the nonvolatile memory can be erased. Therefore, if only the ambient temperature of optical transceiver 1 is abnormal while the function itself of optical transceiver 1 is normal, for example, the log information stored in the nonvolatile memory can be erased to thereby use optical transceiver 1 again.

Moreover, in the production stage of the optical transceiver, an adjustment and an inspection of optical transceiver 1 are carried out. At the time when the adjustment of optical transceiver 1 is done, calibration is conducted so that various parameters such as the measurement value of temperature sensor 30, bias current of laser diode 12, the set value of D/A converter 16 for example become respective optimum values. For example, until a parameter for calibrating the measurement value of temperature sensor 30 becomes an optimum value, it is highly possible that the measurement value of temperature sensor 30 is different from the actual temperature. While the measurement value of the temperature sensor is being calibrated, it is possible that the measurement value of temperature sensor 30 is in error (exceeds a reference value for example), namely optical transceiver 1 erroneously detects an abnormality.

In the present embodiment, when the number of times log information is written in nonvolatile memory 22 reaches a predetermined number of times, log information will not be written thereafter in nonvolatile memory 22. Therefore, the number of times log information is written in nonvolatile memory 22 while parameters are being calibrated can be prevented from increasing. Accordingly, shortening of the lifetime of optical transceiver 1, depending on the number of times log information is written in nonvolatile memory 22, can be prevented.

Moreover, according to the present embodiment, it is also possible to use the ROM protect code so as not to allow log information to be written at all in nonvolatile memory 22 while parameters are being calibrated. For example, the value of the measured temperature is calibrated so as to make the value of the measured temperature correct. In this stage, the ROM protect code is “FFh” (write inhibited). Optical transceiver 1 operates following the flowchart in FIG. 7. Until the value of the measured temperature becomes correct, recording of log information is skipped even if the value of the measured temperature exceeds a reference value.

After the adjustment and the inspection, optical transceiver 1 is rebooted. After the fact that the value of the measured temperature is correct is confirmed, the ROM protect code is changed to “00h” (write permitted). An instruction to change the ROM protect code is sent by means of the above-described testing apparatus for example to control unit 21. After optical transceiver 1 is mounted on host substrate 2, the processes are carried out following the flowcharts in FIGS. 6 and 7.

In the case where optical transceiver 1 is returned for the purpose of analysis of its failure, the log information stored in the nonvolatile memory of optical transceiver 1 is read. Based on this log information, the analysis is conducted. In the case where this optical transceiver 1 can be delivered again, an adjustment and an inspection of optical transceiver 1 are carried out as required. The ROM protect code is set to “80h” and optical transceiver 1 is rebooted. Accordingly, the process shown in the flowchart of FIG. 6 is performed to rewrite all the values (log information) stored in log information storage area 41 (see FIG. 4) to “FFh” and thereafter the ROM protect code is changed to “00h” (write permitted).

Further, according to the present embodiment, in each of optical transceiver 1 and host substrate 2, log information including at least the time is stored. Reference can be made to the log information of optical transceiver 1 and that of host substrate 2 to thereby keep the integrity of an event which occurred when an abnormality occurred to optical transceiver 1. Therefore, the cause of the abnormality of optical transceiver 1 can more accurately be ascertained.

### Second Embodiment

In the first embodiment, the number of times log information is written in the nonvolatile memory in the optical transceiver is limited to one. In the second embodiment, log information can be written more than once. Here, the number of times log information can be written is smaller than the limitation of the number of times the nonvolatile memory can be written. Namely, like the first embodiment, the second embodiment also limits the number of times log information is written in the nonvolatile memory.

An optical transceiver in the second embodiment has a configuration identical to that shown in FIGS. 2 and 3. Therefore, the detailed description of the configuration of the optical transceiver in the second embodiment will not be repeated.

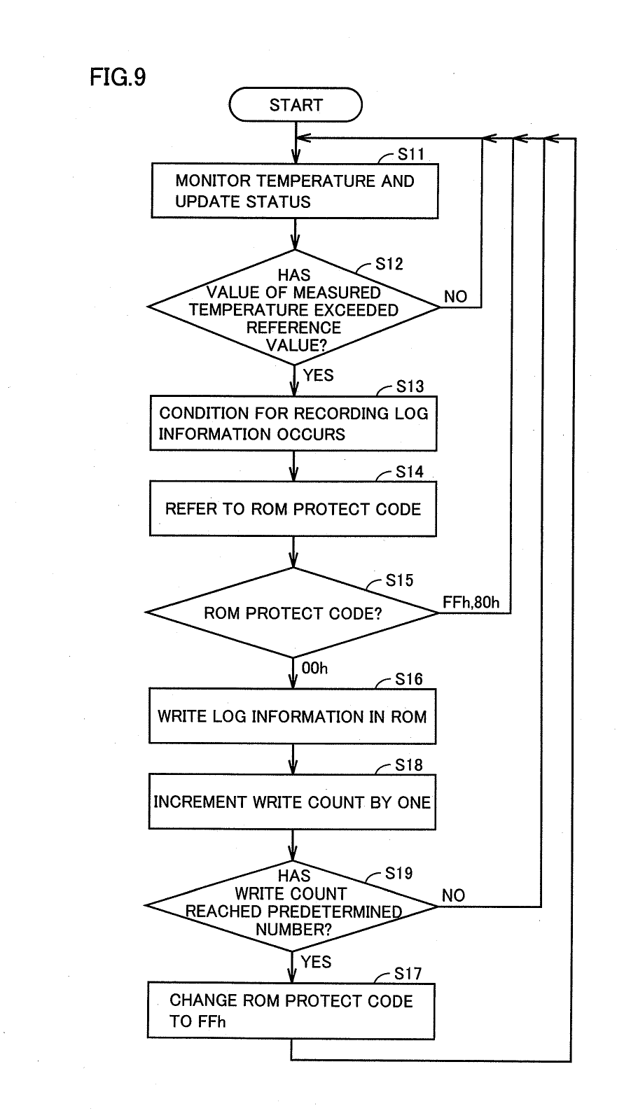

FIG. 9 is a flowchart showing a process of a main routine of the optical transceiver in the second embodiment. It is seen from a comparison between FIGS. 7 and 9 that the process of the main routine of the optical transceiver in the second embodiment differs from the process of the main routine of the optical transceiver in the first embodiment in that the former additionally includes respective operations in steps S18 and S19. The operations in steps S18 and S19 are performed between steps S16 and S17. In the following, the operations in steps S18 and S19 will be described in detail, and the detailed description of the operations in the other steps will not be repeated.

In the present embodiment, control unit 21 holds the number of times, namely write count, log information has been written in nonvolatile memory 22. The initial value of the write count is zero. In step S16, control unit 21 writes the log information in nonvolatile memory 22 (ROM). In step S18, control unit 21 increments the write count by one.

In step S19, control unit 21 determines whether or not the write count has reached a predetermined number of times. While “predetermined number of times” in the present embodiment is more than one, “predetermined number of times” is not particularly limited (five for example). In the case where the predetermined number of times is set to one, the process shown in FIG. 9 is substantially identical to the process in the first embodiment.

When the write count has not reached the predetermined number of times (NO in step S19), the process returns to step S11. When the write count has reached the predetermined number of times (YES in step S19), the process proceeds to step S17.

The operations in steps S18 and S19 are added to thereby enable the log information to be written in nonvolatile memory 22 more than once. In log information storage area 41 shown in FIG. 4, new log information is written and accordingly the new information is added to the currently-stored log information.

Control unit 21 may hold the remaining number of times log information 42 can be written in nonvolatile memory 22. The initial value of the remaining number of times is equal to the above-referenced “predetermined number of times” (five for example). In this case, in step S18, control unit 21 decrements the remaining number of times by one. In step S19, control unit 21 determines whether or not the remaining number of times is equal to zero. When the remaining number of times is larger than zero, the process returns to step S11. When the remaining number of times is equal to zero, the process proceeds to step S17.

In the present embodiment, the process when the optical transceiver is started up is basically identical to the process shown in FIG. 6, except that control unit 21 performs, in step S6, an operation of setting the stored write count (or the remaining number of times) back to the initial value, in addition to the operation of changing the ROM protect code to “00h.”

In the present embodiment, respective operations in steps S16 and S18 or respective operations in steps S16, S18, S17 are performed in one write process.

According to the second embodiment, similar effects to those of the first embodiment can be obtained. In particular, according to the second embodiment, the log information regarding an abnormality which has occurred multiple times, including the abnormality which has occurred first, can be stored in a nonvolatile manner in the optical transceiver. Accordingly, in the case for example where a failing optical transceiver has been returned to a technical expert of the manufacturer of the transceiver, the technical expert of the manufacturer can obtain more detailed information about the situation in which the optical transceiver enters a failure state. For example, the technical expert can know, from the log information, how the state of optical transceiver 1 has changed with time before optical transceiver 1 has finally failed.

### Third Embodiment

In the first and second embodiments, the state where the temperature of the optical transceiver has exceeded a reference value is detected as an abnormality of the optical transceiver. In a third embodiment, multiple types of abnormalities are detected, or another abnormality is detected instead of the abnormality in temperature of the optical transceiver.

The optical transceiver in the third embodiment has a configuration identical to that shown in FIGS. 2 and 3. Therefore, the detailed description of the configuration of the optical transceiver in the third embodiment will not be repeated.

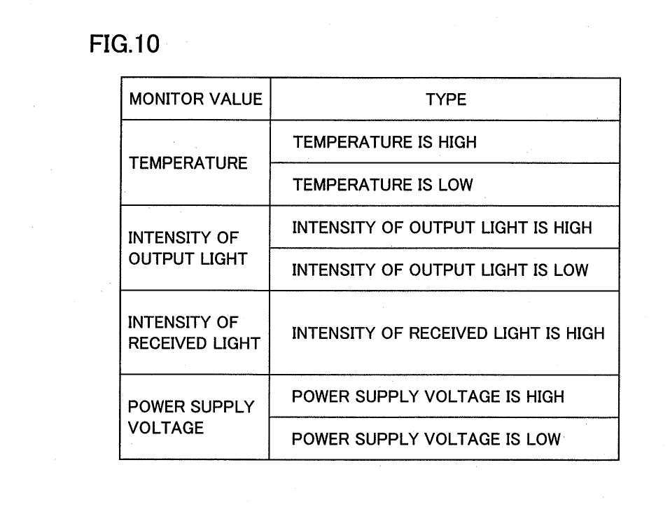

FIG. 10 is a diagram showing abnormalities of the optical transceiver that can be detected by the optical transceiver in the third embodiment. Referring to FIGS. 3 and 10, controller 20 of optical transceiver 1 monitors the temperature of optical transceiver 1, the intensity of light output by laser diode 12, the intensity of light received by photodiode 13, and the power supply voltage supplied to optical transceiver 1. The way to monitor the temperature of optical transceiver 1 by control unit 21 is identical to that in the first and second embodiments.

Monitoring of the intensity of light output by laser diode 12 and the intensity of light received by photodiode 13 is performed for example in the following manner. Transmission circuit 14 outputs to controller 20 a monitor voltage indicating the intensity of light output by laser diode 12. Reception circuit 17 outputs to controller 20 a monitor voltage indicating the intensity of light received by photodiode 13. Controller 20 performs, by means of A/D converter 25, an analog to digital conversion of the monitor voltage which is output from transmission circuit 14 and the monitor voltage which is output from reception circuit 17. A digital signal which is output from A/D converter 25 is a monitor value indicating the intensity of the output light or a monitor value indicating the intensity of the received light. Control unit 21 receives these monitor values. Thus, control unit 21 monitors the intensity of light output by laser diode 12 and the intensity of light received by photodiode 13.

Monitoring of the power supply voltage is performed in the following manner. Voltage sensor 31 (see FIG. 3) outputs to control unit 21 a signal (monitor value) indicating the magnitude of the power supply voltage. Thus, control unit 21 monitors the power supply voltage.

Control unit 21 compares respective monitor values of the temperature, the intensity of the output light, the intensity of the received light, and the power supply voltage with reference values corresponding respectively to the monitor values to thereby detect an abnormality. As the reference values each, a predetermined upper limit, a predetermined lower limit, or both is/are used.

As to an abnormality in temperature, control unit 21 detects an abnormality that the temperature of the optical transceiver is higher than a reference value (predetermined upper limit). In the case where the temperature is high, components (laser diode for example) of the optical transceiver may be damaged. Alternatively, control unit 21 detects an abnormality that the temperature of the optical transceiver is lower than another reference value (predetermined lower limit). The lower limit is set for example to zero. Namely, control unit 21 detects abnormalities in temperature of the optical transceiver not only when the temperature of the optical transceiver has exceeded the upper limit but also when the temperature thereof has fallen below zero (below the freezing point).

Usually, in order to keep constant the intensity of the output light, the temperature of the laser diode is managed by, for example, a Peltier element. When a difference between the temperature of the laser diode and its ambient temperature becomes too large, it becomes difficult to manage the temperature of the laser diode and thereby keep the temperature constant. Due to this, it becomes difficult to keep constant the intensity of the light output by the laser diode. Therefore, control unit 21 also detects an abnormality of optical transceiver 1 when the temperature of the optical transceiver is below the lower limit.

As to an abnormality in intensity of the output light, control unit 21 detects an abnormality that the intensity of the output light is higher than a predetermined upper limit. The fact that the intensity of the output light is too high is not preferable in terms of the safety for example (safety for human eyes for example). Alternatively, control unit 21 detects an abnormality that the intensity of the output light is lower than a predetermined lower limit. In the case where the intensity of the output light is lower than the lower limit, laser diode 12 may have reached the end of its lifetime. For example, in the case where the actual lifetime is shorter than a lifetime which has been expected in advance, an abnormality may have occurred to laser diode 12 or driver 15 (see FIG. 2) which drives laser diode 12.

As to an abnormality in intensity of the received light, control unit 21 detects an abnormality that the intensity of the received light is higher than a predetermined upper limit. Usually, a photodiode having a high sensitivity is used for optical communication. In the case where the intensity of an optical signal which is input to the photodiode adapted to optical communication is too large, the photodiode may be damaged. Therefore, in the case where the intensity of the optical signal which is input to the photodiode adapted to optical communication exceeds the upper limit, control unit 21 detects an abnormality of optical transceiver 1.

As to an abnormality in power supply voltage, control unit 21 detects an abnormality that the power supply voltage is higher than a predetermined upper limit. In the case where the power supply voltage is higher than the upper limit, components (controller 20 for example) of the optical transceiver may be damaged. Alternatively, control unit 21 detects an abnormality that the power supply voltage is lower than a predetermined lower limit. In the case where the power supply voltage is lower than the lower limit, the intensity of light output by laser diode 12 for example may be decreased, or it is possible that the operation of controller 20 becomes unstable. Therefore, control unit 21 detects an abnormality of optical transceiver 1 when the power supply voltage is lower than the lower limit.

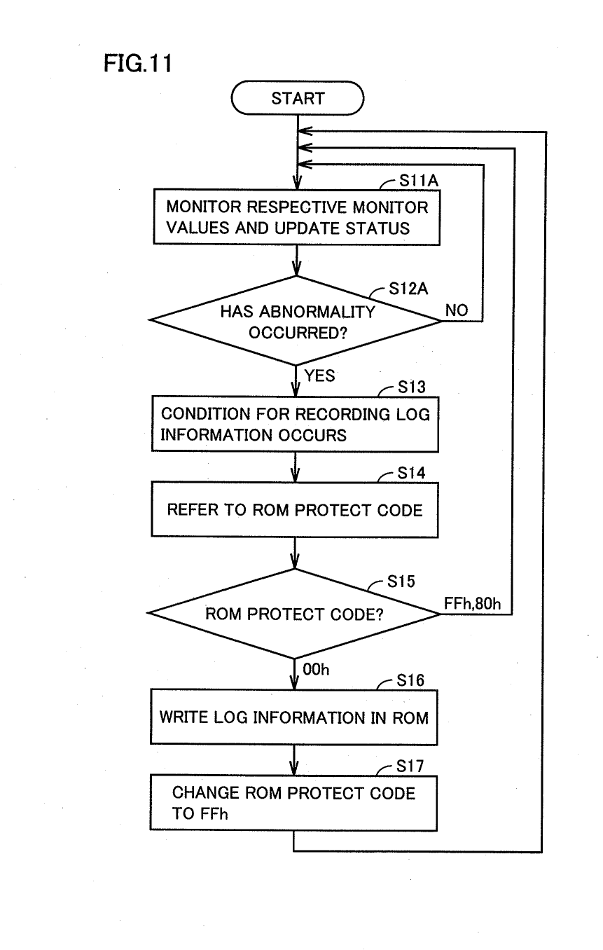

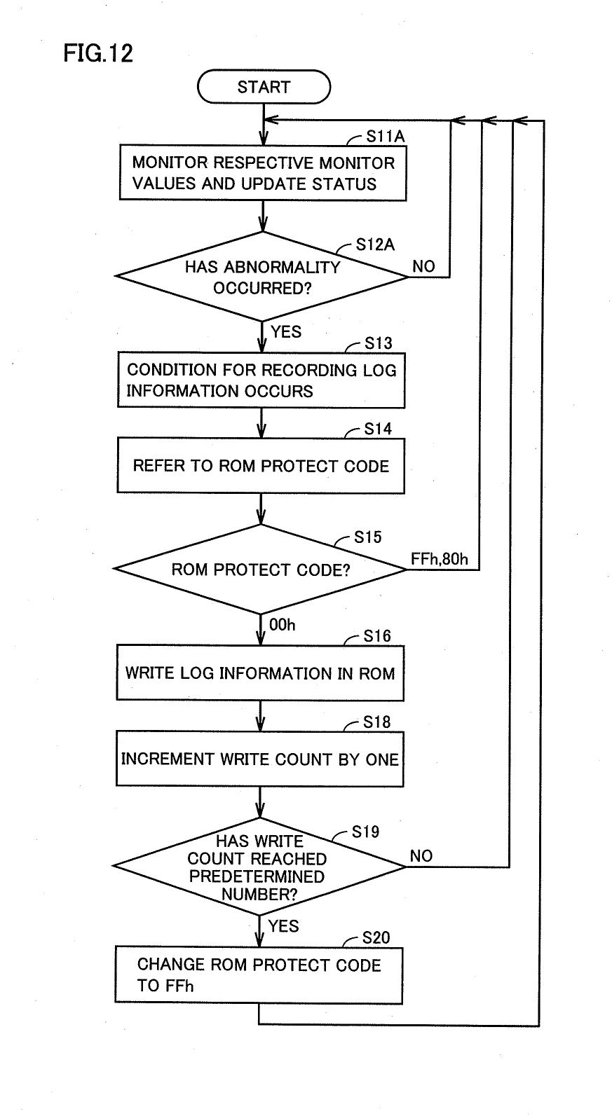

FIG. 11 is a flowchart showing a process of a main routine of the optical transceiver in the third embodiment. It is seen from a comparison between FIGS. 7 and 12 that the process of the main routine of the optical transceiver in the third embodiment differs from the process of the main routine of the optical transceiver in the second embodiment in that operations in steps S11A and S12A are performed in the former process instead of the operations in steps S11 and S12. In the following, the operations in steps S11A and S12A will be described in detail, and the detailed description of the operations in the other steps will not be repeated.

In step S11A, control unit 21 monitors respective monitor values of the temperature, the intensity of the output light, the intensity of the received light, and the power supply voltage. Specifically, control unit 21 compares the monitor values with respective corresponding reference values (upper limit or lower limit or both). In step S12A, control unit 21 determines whether or not an abnormality has occurred. For example, when at least one of respective monitor values of the temperature, the intensity of the output light, the intensity of the received light, and the power supply voltage is higher than the upper limit or lower than the lower limit, it is determined that an abnormality has occurred. In this case (YES in step S12A), the process proceeds to step S13. In contrast, when each monitor value is not more than the upper limit, or not less than the lower limit, or not more than the upper limit and not less than the lower limit, it is determined that an abnormality has not occurred. In this case (NO in step S12A), the process is returned to step S11A.

According to the process shown in FIG. 11, in the case where an abnormality occurs to at least one of the temperature, the intensity of the output light, the intensity of the received light, and the power supply voltage, a condition for recording log information occurs (step S13). Log information regarding this abnormality is written in nonvolatile memory 22 (step S16). After this, log information is inhibited from being written in nonvolatile memory 22 (step S17). The log information stored in nonvolatile memory 22 may include information regarding one abnormality or a plurality of abnormalities. Therefore, in the case where an optical transceiver which has failed is returned to a technical expert of the manufacturer of the transceiver for example, the technical expert of the manufacturer can obtain more detailed information about the situation in which optical transceiver 1 enters a failure state.

FIG. 12 is a flowchart showing another example of the process of the main routine of the optical transceiver in the third embodiment. The process shown in FIG. 12 is basically identical to the process shown in FIG. 9, except that operations in steps S11A and S12A are performed in the former process instead of the operations in steps S11 and S12. According to the flowchart shown in FIG. 12, log information can be written in nonvolatile memory 22 multiple times. A technical expert of the manufacturer can obtain more detailed information about the situation in which optical transceiver 1 enters a failure state.

Further, in steps S11A and S12A, abnormalities detected by control unit 21 may be fixed to one type of abnormality. In the first and second embodiments, the fact that the temperature of the optical transceiver has exceeded a reference value is detected as an abnormality of the optical transceiver. Therefore, in the present embodiment, one type of abnormality other than the abnormality that the temperature is high, among the multiple types of abnormalities shown in FIG. 10, may be detected in steps S11A and S12A.

Further, the abnormalities of the optical transceiver are not limited to the types of abnormalities shown in FIG. 10. Instead of any of the multiple types of abnormalities shown in FIG. 10 or instead of the multiple types of abnormalities shown in FIG. 10, another type of abnormality may be detected.

The optical transceiver has been illustrated herein as one specific form of the optical communication module according of the present invention. The optical communication module of the present invention, however, is not limited to the one like the optical transceiver having both the transmission capability and the reception capability. The optical communication module of the present invention may have only one of the transmission capability and the reception capability. Therefore, the optical communication module of the present invention may be an optical receiver or an optical transmitter.

It should be construed that the embodiments disclosed herein are by way of illustration in all respects, not by way of limitation. It is intended that the scope of the present invention is defined by claims and encompasses all modifications and variations equivalent in meaning and scope to the claims.

### REFERENCE SIGNS LIST

1 optical transceiver; 1 a front face (optical transceiver); 2 host substrate; 3 host CPU; 4, 22 nonvolatile memory; 5 casing; 11 optical device; 12 laser diode; 13 photodiode; 14 transmission circuit; 15 driver; 16, 26 D/A converter; 17 reception circuit; 18 amplifier; 19, 25 A/D converter; 20 controller; 21 control unit; 23 volatile memory; 24 bus; 27, 29 data bus interface; 28 logic port; 30 temperature sensor; 31 voltage sensor; 40 memory map; 41 log information storage area; 42 log information; 42a second count value; 42b status; 42c alarm information; 42d temperature monitor information; 43 ROM protect code; 101 optical communication apparatus

1. An optical communication module insertable in and removable from a host substrate, comprising:
a control unit for detecting an abnormality of said optical communication module; and
a nonvolatile memory,
said control unit generating log information regarding a detected abnormality, and writing the generated log information in said nonvolatile memory to add the log information to log information having been stored in said nonvolatile memory and, after the number of times the log information has been written in said nonvolatile memory has reached a predetermined number of times, said control unit not writing the log information in said nonvolatile memory.

2. The optical communication module according to claim 1, wherein said control unit erases the log information written in said nonvolatile memory, in accordance with an erasure instruction that is given to said control unit.

3. The optical communication module according to claim 1, wherein said log information includes at least information regarding a time identifying occurrence of an abnormality of said optical communication module.

4. The optical communication module according to claim 1, wherein said abnormality detected by said control unit includes at least one of an abnormality in temperature of said optical communication module, an abnormality in intensity of communication light of said optical communication module, and an abnormality in power supply voltage of said optical communication module.

5. The optical communication module according to claim 1, wherein said predetermined number of times is a plurality of times smaller than a limitation of the number of times said nonvolatile memory is written.

6. A method for recording a log of an optical communication module, comprising the steps of:
detecting an abnormality of an optical communication module insertable in and removable from a host substrate;
writing, in a nonvolatile memory mounted in said optical communication module, log information regarding the abnormality of said optical communication module to add the log information to log information having been stored in said nonvolatile memory; and
inhibiting the log information from being written in said nonvolatile memory after the number of times the log information has been written in said nonvolatile memory has reached a predetermined number of times.

7. An optical communication apparatus comprising:
a host substrate; and
an optical communication module including a first nonvolatile memory and being insertable in and removable from said host substrate,
said optical communication module detecting an abnormality of said optical communication module and writing, in said first nonvolatile memory, first log information regarding the detected abnormality to add the first log information to log information having been stored in said nonvolatile memory,
said host substrate including
a control unit monitoring a situation of said optical communication apparatus and generating second log information regarding the monitoring, and
a second memory storing said second log information in a nonvolatile manner,
after the number of times the first log information has been written has reached a predetermined number of times, said optical communication module not writing the first log information in said first nonvolatile memory, and
said first log information and said second log information each including at least information regarding a time.
